(19) United States
(12) Patent Application Publication
(10) Pub. No.: US 2002/0156952 A1
(43) Pub. Date: Oct. 24, 2002

(54) Communication control apparatus, communication system and communication control method

(76) Inventor: Atsuo Shono, Tachikawa-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/107,255

(22) Filed: Mar. 28, 2002

(30) Foreign Application Priority Data
Mar. 30, 2001 (JP) 2001-101854

(51) Int. Cl. G06F 13/00

(52) U.S. Cl. 710/104

(57) ABSTRACT

A controller resets a whole bus and enters connection waiting state upon detecting disconnection of a USB device, registers all connected USB devices by giving sequential addresses beginning from a predetermined value, communicates with each of registered USB devices, and responsive to a response from the USB device, sequentially broadcasts data to all the registered USB devices or transmits the data to a particular USB device. A bus configuration register registers one of three device types including a hub, USB device, and others based on a device address, wherein the bus configuration register is cleared when said controller enters the connection waiting state. A pattern determination unit, responsive to detection of connection of a USB device, determines whether or not the connected device is the supporting device based on whether or not a predetermined portion of a configuration descriptor of the connected device matches a predetermined pattern.

### CROSS-REFERENCE TO RELATED APPLICATIONS

This application is based upon and claims the benefit of priority from the prior Japanese Patent Application No. 2001-101854, filed Mar. 30, 2001, the entire contents of which are incorporated herein by reference.

### BACKGROUND OF THE INVENTION

1. Field of the Invention

The present invention relates to a communication control apparatus between USB (Universal Serial Bus) devices, a communication system, and a communication control method.

2. Description of the Related Art

In a USB system, a USB host (hereinafter simply called the “host”) positioned at a root of a device tree (a tree-shaped USB topology) recognizes a USB peripheral device (hereinafter called the “device”) existing at a terminal point of the device tree and transmits/receives data to/from the device on a one-to-one basis, as illustrated in FIG. 1. A “hub” (hereinafter called the “hub”) positioned at a node of the device tree is a special device which has a function of relaying a packet transmission from the upstream (on the host side) to the downstream (on the device side), and from the downstream to the upstream, and a function of detecting connection/disconnection to/from a device located at a downstream node/terminal point.

A device can be directly coupled to the host or connected to the downstream of the hub. The hub can also be directly coupled to the host and connected to the downstream of the hub in a manner similar to a general device.

The relationship between the host and a device in the USB connection is asymmetric. In other words, all communications are started by the host, and a device responds to a communication started by the host.

Therefore, communication packets from the host to the device are sent across the entire tree device through the hub. The device sees an address field included in the packet, and returns a response to the host when it recognizes a communication destined thereto. A response packet in this event is relayed in the upstream direction through the hub.

For using a device, the host communicates with the device on a one-to-one basis.

A one-to-one virtual communication path between the host and a device on the USB is called a “pipe.” As illustrated in FIG. 2, communications between the host and a device are classified into a control type, a bulk type, an interrupt type, and an isochronous type.

A communication for transmitting data from the host to a device is called “OUT,” while a communication for the host to receive data from a device is called “IN.”

CRC (Cyclic Redundancy Code) is added to a USB communication packet, so that the reception side can detect whether or not data can be correctly received by checking the data and CRC. In a certain type of handshake communication, a protocol is defined for executing a retry when an error is detected by the CRC check.

For the control type communication and bulk type communication, a constant bandwidth is assigned collectively for both, so that the throughput or latency is not ensured for each pipe. On the other hand, the worst-case latency is ensured for each pipe in the interrupt type, while a bandwidth allocated to each frame is ensured in the isochronous type. The management of the latency and bandwidth is performed by the host. The host also controls the scheduling of communications in accordance with an allocated bandwidth, and a retry when a communication error is detected by handshaking. The host also sends a SOF (Start of Frame) packet every frame (1 ms), which is a timing unit of communications, in the interrupt type and isochronous type.

Upon receipt of a communication packet from the host, a device performs a handshake response to the host, interprets handshaking from the host, and responds to a retry request from the host.

Functions which should be provided in the host and device are shown in FIG. 3. As shown in FIG. 3, as bus-level functions which should be provided in the USB host and device, the host executes bus-level processing for each of handshake response and interpretation, retry, bandwidth allocation, communication schedule, transmission of SOF, and detection of connection/disconnection of a device, while the device executes bus-level processing for handshake response and interpretation and retry response.

Generally, a personal computer or a personal computer equivalent having a CPU (hereinafter called the “PC”) is used as a host. The PC runs system software corresponding to a built-in USB host controller (hardware) to implement the foregoing bus-level processing. The system software manages the latency and allocation of bandwidth, and the USB host controller executes the communication scheduling, and a retry when an error is detected, based on manipulations through software.

In the following, description will be made on device connection/disconnection detection processing performed by a conventional host.

As a device is connected to or disconnected from anywhere on a device tree, this event is detected as a port status change in a hub port at that location.

FIG. 4 shows processing for detecting a port status change, which is periodically performed by the host for each hub. The host also performs similar processing for a port possessed thereby by directly detecting a port status change.

All hubs have a control pipe (control type) and a status change pipe (interrupt IN type) between themselves and the host. The host periodically transmits a data read request to the hubs through the status change pipes (step S41). In response to the request, the hub responds a status change when the status changes. Upon receipt of the response of the status change (YES at step S42), the host reads the port status (step S43). The host determines at step S44 whether or not the status change indicates that a device is connected. When the host detects that a device is connected, the host stores this event, and sends a port reset signal to a control pipe of the associated hub (step S45). On the other hand, when no device connection is detected, the host determines at step S46 whether or not a reset is completed. When the reset is completed, the host stores a device connection at step S47. When the reset is not completed, the host determines at step S48 whether or not the status change involves a disconnection. Upon detection of a device disconnection, the host stores this event at step S49. A manipulation to a hub from the host is performed through the control pipe.

FIG. 5 shows an outline of conventional enumeration (device recognition) processing. The enumeration begins with detection of devices connected to hub ports (including the port of the host) which have been powered on. A device connection at a downstream hub is detected through the hub status change pipe. Upon receipt of a reset signal from the upstream, a device starts up with a default address (address 0) being regarded as destined to itself, and is assigned a unique device address by a control command sent from the host to operate subsequently.

Specifically, the host detects a device speed at step S50, and assigns an address to the device at step S51. The host needs to record information related to each of devices in a tree shape corresponding to the bus topology in preparation for post-processing at the time of device disconnection, later described. Recorded information includes information for calling driver software for software-based post-processing, in addition to a descriptor for acquiring a device. As the host acquires a variety of descriptors (step S52), the host updates device tree information (step S53). Then, the host determines whether a hub or a device is connected (step S54). When a hub is connected, the host loads a hub driver (step S55), sets a port status change pipe (step S56), and powers on the associated hub port (step S57). On the other hand, when the host determines that a device is connected, the host selects and loads a device driver (step S58), and initializes the device for using the device (step S59).

Next, FIG. 6 shows conventional device disconnection processing.

The system software of the host stores the device tree information corresponding to the bus topology on a main storage, so that the host can recognize a disconnected location, when a device is disconnected somewhere on the bus (step S61). The system software of the host performs post-processing as required for driver software associated with a portion of the tree potentially affected by the disconnection and application software which has been using the device (steps S62, S63, S64). The system software of the host deletes the device tree information, and releases an assigned device address and system resources used by associated software to prepare for later reuse (step S65). In this event, portions not related to the disconnected location are not affected.

In the device which uses a microprocessor having a device controller function, it is often the case that hardware is responsible for a physical layer and a low-level protocol layer (electrical signal conversion, assembly of packets, handshake response), and firmware is responsible for handshake interpretation, retry response, and upper-layer processing.

As described above, while the conventional USB system defines a communication control scheme between the host and devices, no feature has been defined for directly communicating data between devices. Therefore, for communicating data between devices, the host intervenes the communication at all times. Specifically, for communicating data between devices, the host is used to run device drivers corresponding to the respective drivers, and application software for intervening the communication of data.

FIG. 7 generally shows a feature of communications between devices which have been so far employed.

As the user connects a data sending device 71 and a data receiving device 72 to a host, USB system software 73 of the host uses USB hardware 74 to enumerate these devices, and loads and executes a driver 75 for device 71 and a driver 76 for device 72. Then, a transfer control software 77 initiated by the user in the host reads data from the device 71 through the driver 75 for the device 71, and writes the read data into the device 72 through the driver 76 for the device 72 to transfer data from the device 71 to the device 72.

In this manner, conventionally, the host is assumed to be implemented by a PC on which a variety of software (system software, device drivers, application software) can be installed, and which has the CPU capability and memory capacity for executing the software.

Therefore, there is a problem that data cannot be communicated between devices unless a PC is used as a host. Particularly, in a use environment which lacks a PC, a problem arises that a small-sized portable communication device such as a cellular phone having device functions, a small-sized portable input/output device, and a small-sized portable external storage device cannot be interconnected through USB for use in data transmission between the devices.

### BRIEF SUMMARY OF THE INVENTION

The present invention is directed to a communication control apparatus, a communication system, and a communication control method which are capable of transmitting data between devices.

According to an embodiment of the present invention, a communication control apparatus comprises a controller configured to reset a whole bus and enter a connection waiting state upon detecting a disconnection of a device, register all connected devices by giving sequential addresses beginning from a predetermined value, communicate with each of registered devices, and responsive to a response from the device, sequentially broadcast data to all the registered devices or transmit the data to a particular device; a bus configuration register configured to register one of three device types including a hub, a device, and others based on a device address, wherein the bus configuration register is cleared when the controller enters the connection waiting state; and a pattern determination unit, responsive to detection of a connection of a device, configured to determine whether or not the connected device is the supporting device based on whether or not a predetermined portion of a configuration descriptor of the connected device matches a predetermined pattern.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a diagram showing a conventional USB communication system;

FIG. 2 is a diagram showing several types of conventional USB communication pipes;

FIG. 3 is a diagram showing bus-level functions which should be possessed by a conventional USB host and device;

FIG. 4 is a flow chart showing conventional port status change processing;

FIG. 5 is a flow chart showing conventional enumeration processing;

FIG. 6 is a flow chart illustrating conventional disconnection processing;

FIG. 7 is a schematic diagram showing a feature of a conventional data transfer between devices;

FIG. 8 is a diagram showing a whole USB communication system which employs a root repeater as a first embodiment of a USB communication control apparatus according to the present invention;

FIG. 9 is a block diagram showing the configuration of the root repeater of the first embodiment;

FIG. 10 is a diagram showing state transitions of the root repeater;

FIG. 11 is a flow chart showing processing in a connection waiting state of the root repeater;

FIG. 12 is a flow chart showing processing in an enumeration state of the root repeater;

FIG. 13 is a flow chart showing processing in a relay state of the root repeater;

FIG. 14 is a flow chart showing processing in a hub port initialization state of the root repeater;

FIG. 15 is a diagram for explaining a feature of a data transfer between devices in the USB communication system; and

FIG. 16 is a diagram showing a root repeater as a second embodiment of the USB communication control apparatus according to the present invention, which comprises a hub integrated with a corresponding device.

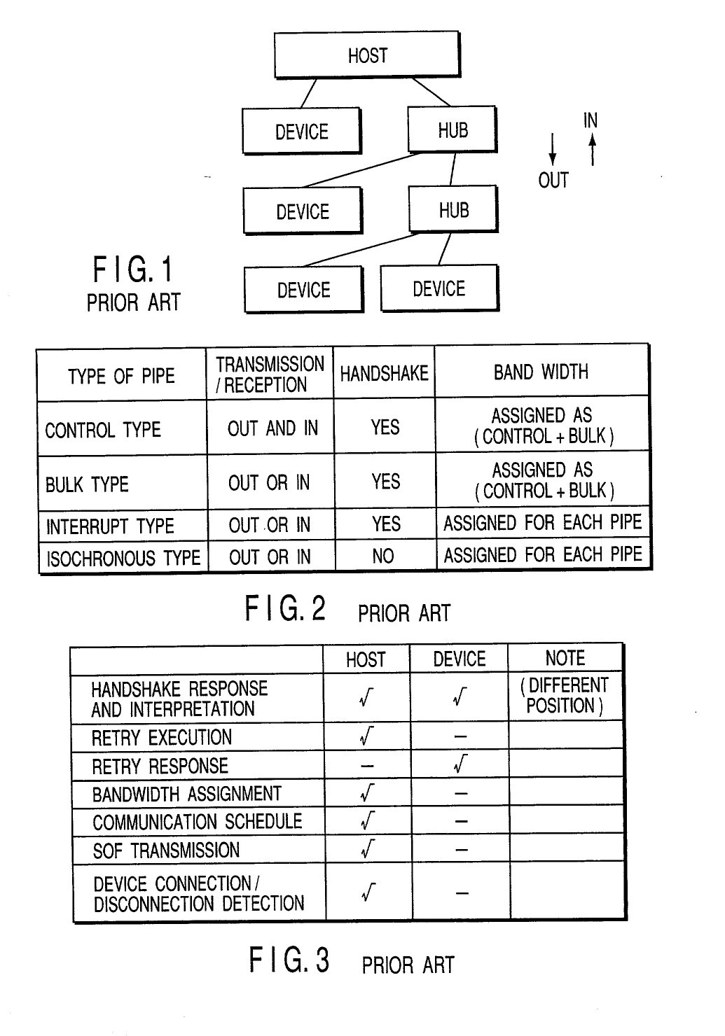

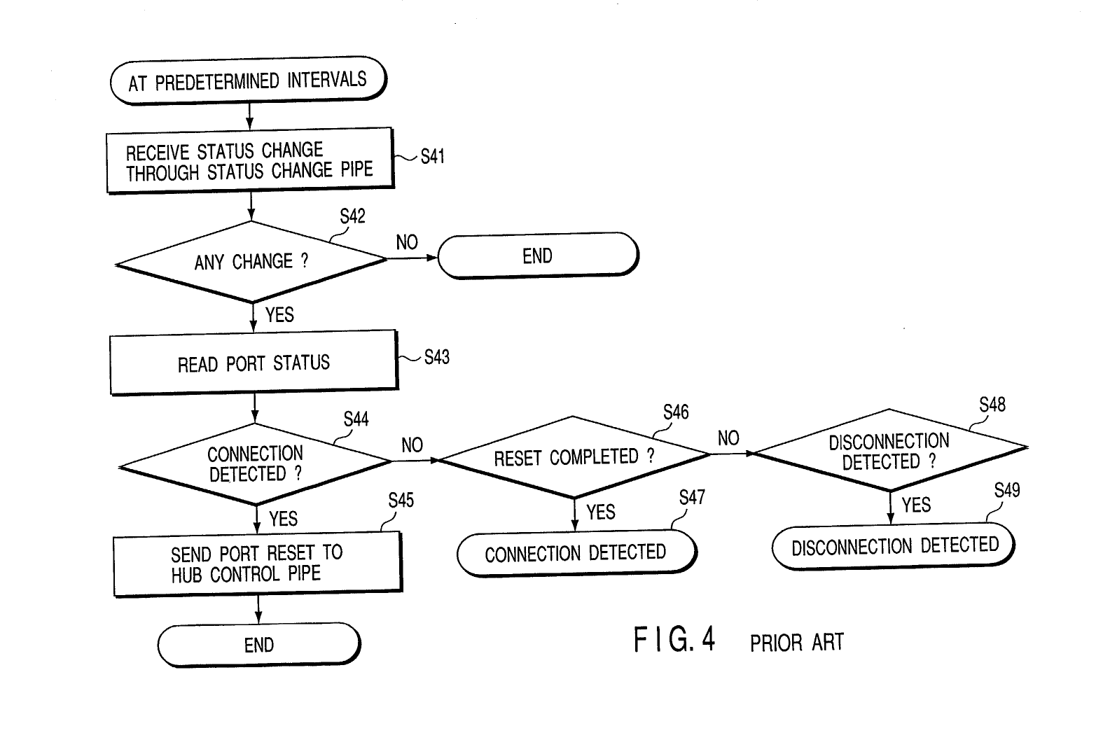

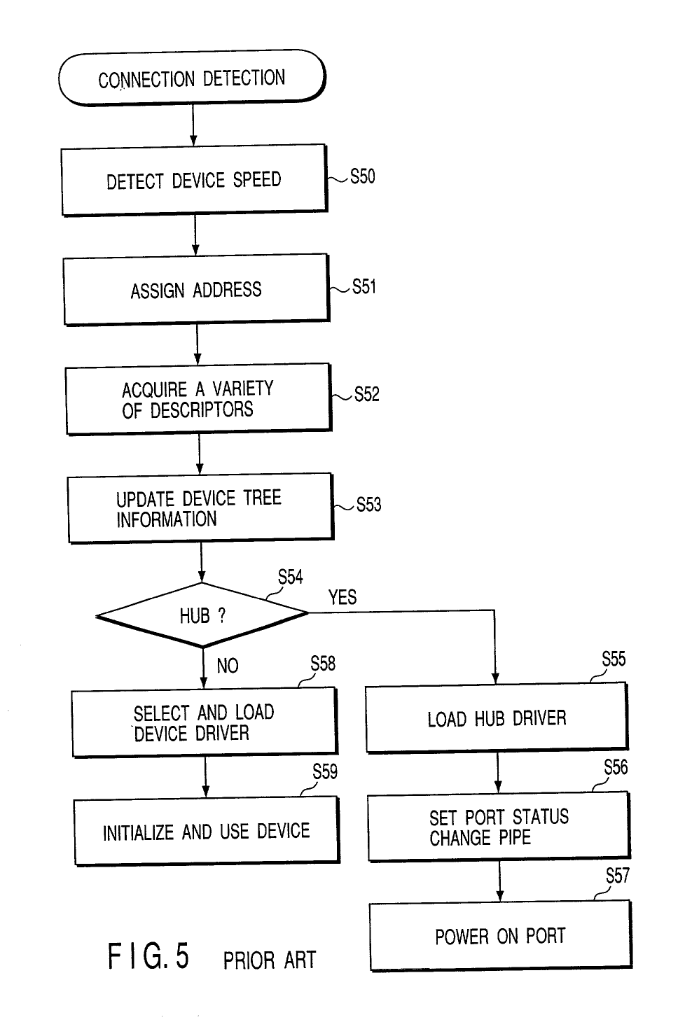

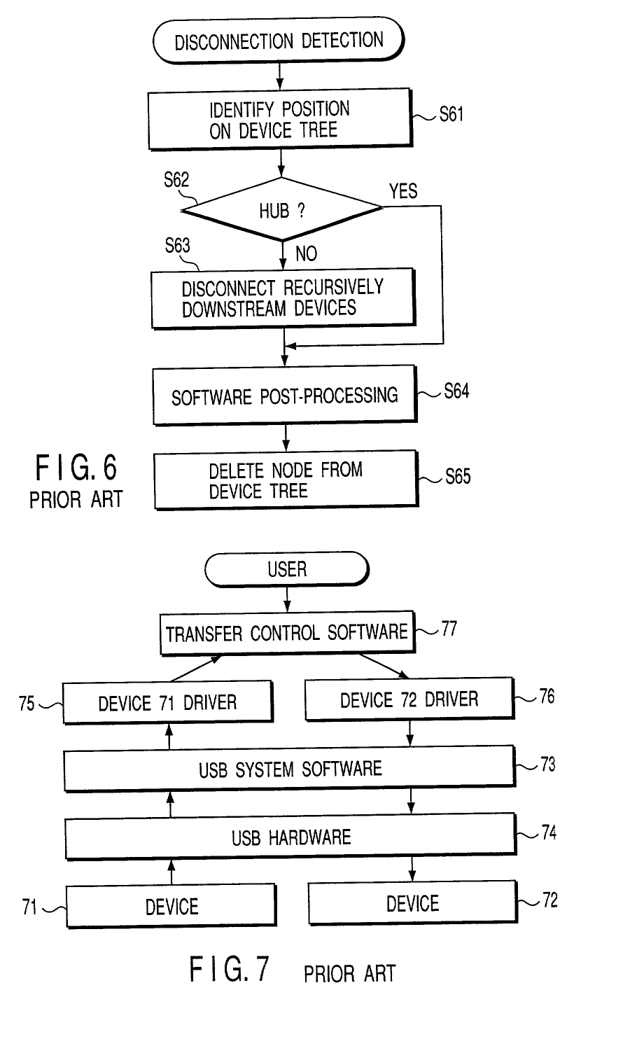

### DETAILED DESCRIPTION OF THE INVENTION

An embodiment of a USB communication control apparatus according to the present invention will now be described with reference to the accompanying drawings.

First Embodiment

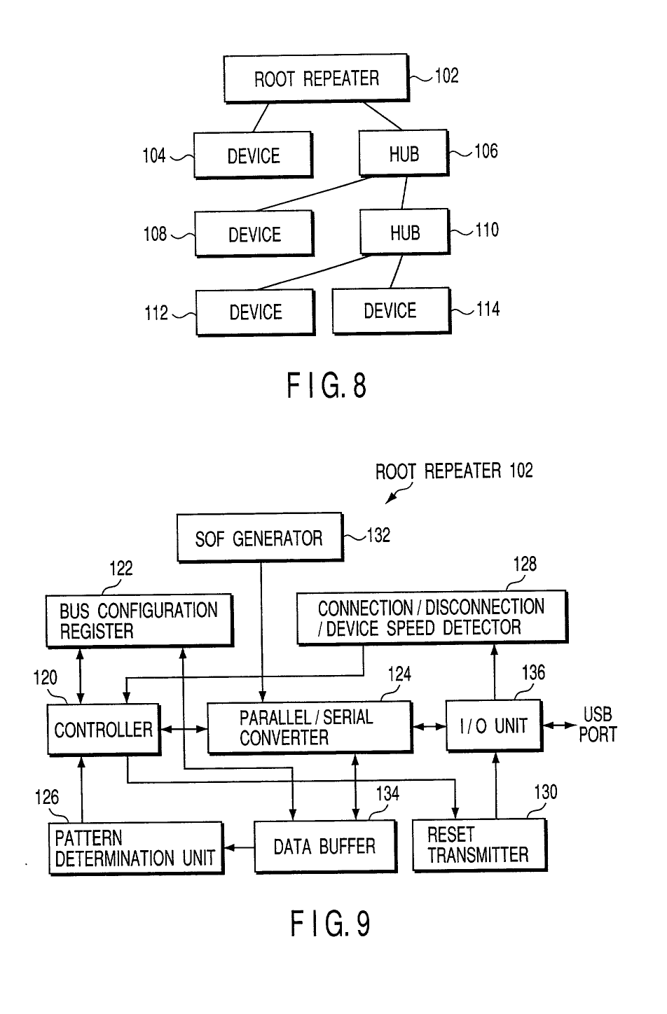

FIG. 8 is a block diagram showing a whole USB communication system which comprises a root repeater, which is one embodiment of the present invention, devices, and a hub.

The root repeater 102 substitutes for a conventional host including PC. However, the root repeater 102 does not require the CPU capability for installing and executing a variety of software (system software, device drivers, application software) conventionally possessed by the host and the memory capacity.

The bus topology is similar to the prior art, wherein hubs 106 and 110, identical to the prior art, can be used to connect a large number of devices 104, 108, 112, and 114 as a single USB system. One-to-multiple communications can be performed between devices in a non-fixed manner by sequentially performing a plurality of one-to-one communications between the root repeater 102 and devices. In other words, while the USB is only capable of one-to-one communication and is incapable of broadcasting, the USB can substantially achieve the broadcasting by sequentially performing one-to-one communications.

FIG. 9 is a detailed block diagram showing one embodiment of the root repeater 102.

A controller 120 is connected to a bus configuration register 122, a parallel/serial converter 124, a pattern determination unit 126, a connection/disconnection/device speed detector 128, and a reset transmitter 130 for controlling the operation of these components.

The bus configuration register 122 is also connected to a data buffer 134, and communicates bus configuration information (e.g., a type of a device connected to a USB port, in this embodiment, the type includes three types: a USB device, a hub, a non-USB device) and hub control pipe information acquired by enumeration with the data buffer 134, and stores such information therein.

The parallel/serial converter 124 is also connected to the data buffer 134 and an I/O unit 136, assembles and disassembles serial bit trains on the USB, and communicates data with the data buffer 134.

The pattern determination unit 126 is also connected to the data buffer 134, and refers received data loaded in the data buffer 134 to notify the controller 120 of matching with a particular pattern. The reset transmitter 130 outputs a reset signal defined in accordance with the USB specifications in response to an instruction from the controller 120 to a USB port (not shown) through the I/O port 136.

An SOF generator 132 has priority over the controller 120 and makes the parallel/serial converter 124 to generate SOF packets. The data buffer 134 is provided for temporarily storing transmission/reception data under control of the controller 120. The I/O unit 136 is used to transmit and receive data therethrough, and mutually converts externally communicated USB signals and local signals at a port.

In the following, processing in each component will be described.

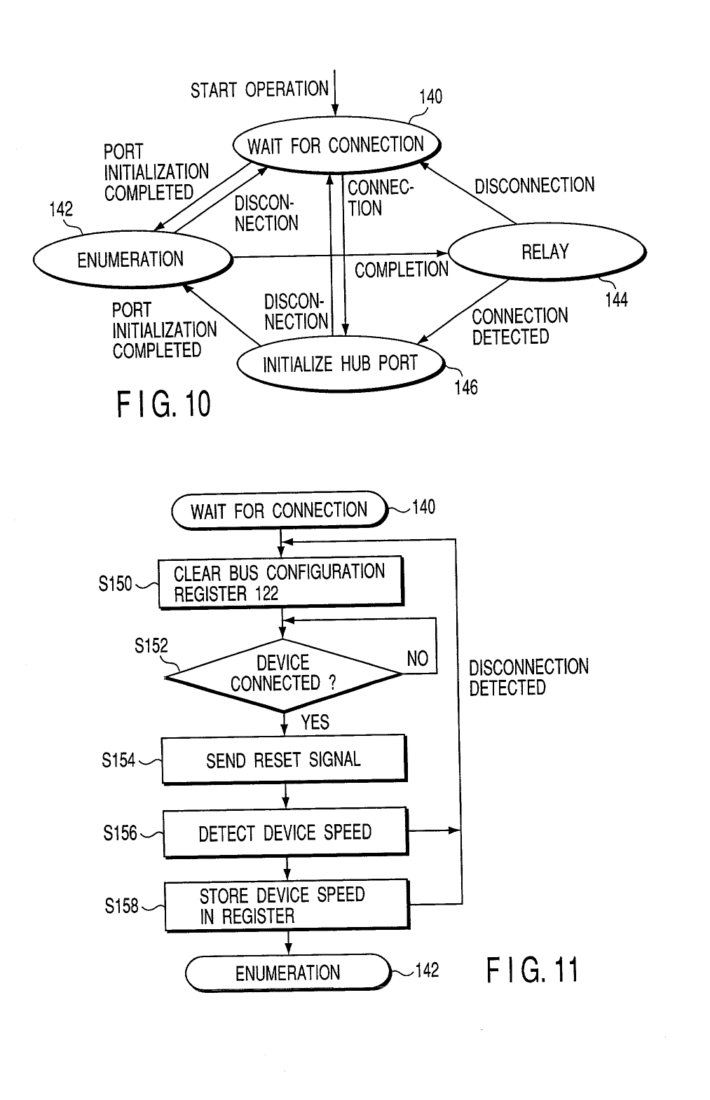

FIG. 10 is a transition diagram showing the processing of the controller 120.

The root repeater 102 of this embodiment enters a connection waiting state 140, as it begins the operation. When a device is connected to a connection port of the root repeater 102 in the connection waiting state 140, the root repeater 102 transits to a port initialization state 146, and again transits to an enumeration state 142 when the initialization is completed. As the enumeration is completed in the enumeration state 142, the root repeater 102 transits to a relay state 144. As the root repeater 102 detects a device connected to a hub on the bus in the relay state 144, the root repeater 102 transits to a hub port initialization state 146, and returns to the connection waiting state 140 when the device at that port is disconnected.

In this manner, the root repeater 102 of this embodiment always enters the connection waiting state 140 not only when it begins the operation but also when a device is disconnected anywhere on the bus. In the connection waiting state 140, the contents set in the bus configuration register 122 are once cleared (the entire bus is reset). Subsequently, the enumeration is performed again for the entire bus, device addresses are assigned from an initial value (generally chosen to be 1) in a regular manner (generally in order), and the configuration result is set in the bus configuration register 12. This ensures that devices existing on the bus always have regular (for example, sequential) device addresses starting from the initial value (for example, 1), so that the root repeater 102 need not store a device tree topology. Therefore, the bus configuration register 122 having a smaller capacity and a simpler configuration can be used, as compared with device tree information recorded by the conventional host.

In the following, description will be made on the control operation performed by the root repeater 102 according to the present invention.

FIG. 11 is a flow chart illustrating the processing in the connection waiting state 140 of the root repeater 102.

As the root repeater 102 enters the connection waiting state 140, the controller 120 once clears the contents set in the bus configuration register 122 at step S150. At step S152, the root repeater 102 waits for a notice of device connection from the connection/disconnection/device speed detector 128. As the detector 128 detects a device connected to a hub in response to a signal from the I/O unit 136, the controller 120 makes the reset transmitter 130 to send a reset signal which is transmitted to the associated device through the I/O unit 136 at step S154. As the reset is completed, the connection/disconnection/device speed detector 128 acquires a notice of a device speed sent from the device through the I/O unit 136. As the device speed is acquired, the controller 120 stores the device speed in the bus configuration register 122 at step S158, and the root repeater 102 transits to the enumeration state 142. If the root repeater 102 is notified of a device disconnected from a hub, to which the device has been connected, at step S156 or S158, the flow returns to step S150.

In this embodiment, by providing the processing in the connection waiting state 140 (FIG. 11), the whole bus can be reset to start the enumeration for the whole bus configuration when the operation is started, and when a device is disconnected anywhere on the bus. Then, a new system configuration at that time is set in the bus configuration register 122. For this reason, since it can be ensured that devices existing on the bus always have regular device addresses starting from the initial value, the root repeater 102 need not store the device tree topology, so that the bus configuration register 122 having a smaller capacity and a simpler configuration can be used, as compared with device tree information recorded by the conventional host.

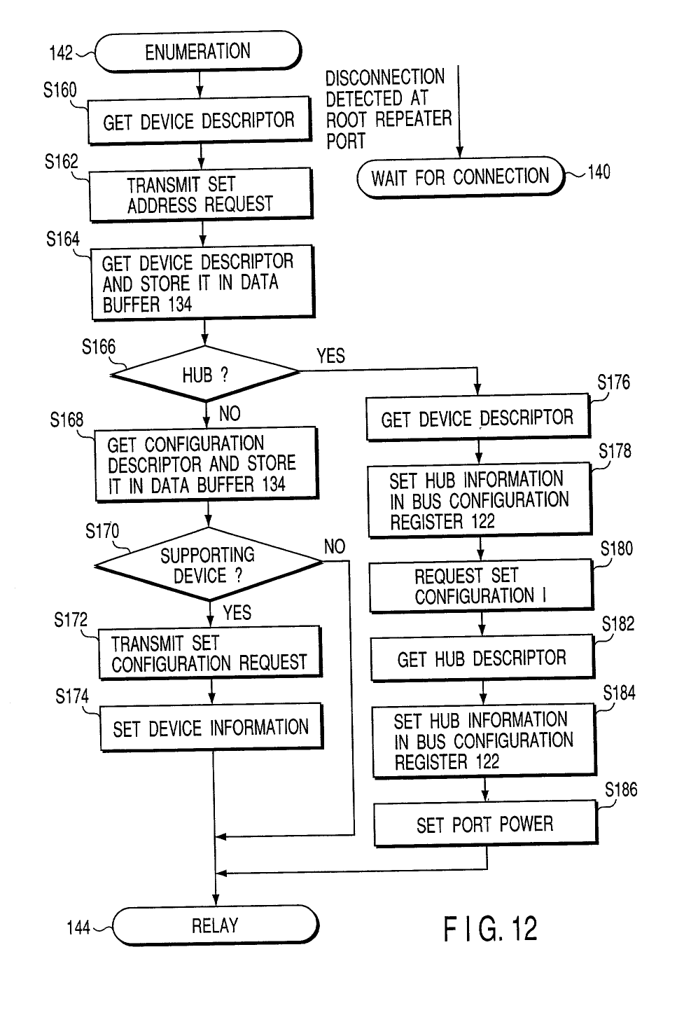

FIG. 12 is a flow chart showing the processing in the enumeration state 142 of the root repeater 102.

In the enumeration state 142, the controller 120 acquires a device descriptor using a default address to get a communication packet size at step S160.

At step S162, the controller 120 transmits a set address request using the default address. This address sequentially increments from a predetermined initial value (for example, 1). At step S164, upon acquisition of the device descriptor (again), which is a response to the request, the controller 120 stores the device descriptor in the data buffer 134. At step S166, the pattern determination unit 126 checks (a pattern of) a class code included in the descriptor to determine whether or not a connected device is a hub by comparing the pattern of the class code with a predetermined pattern of the hub.

When the connected device is not a hub, the controller 120 acquires a device configuration descriptor and stores the device configuration descriptor in the data buffer 134, at step S168. At step S170, the pattern determination unit 126 checks a bit pattern at a predetermined portion of the configuration descriptor to determine whether or not the connected device is a device which supports a communication through the root repeater 102 of this embodiment (hereinafter called the “supporting device” or simply USB device) by comparing the bit pattern at the predetermined portion of the configuration descriptor with a predetermined pattern of supporting device. For example, this determination can be made by predefining the pattern at the first portion the configuration descriptor to an interface having a unique class code pattern. When the pattern determination unit 126 determines that the connected device is the supporting device, the controller 120 requests to set a predetermined configuration at step S172.

At step S174, the controller 120 “initializes a data toggle of a relay communication pipe,” and “registers a device supporting a communication through the root repeater 102 at an assigned address” in the bus configuration register 122.

In the USB specifications, the configuration descriptor is structurally defined, so that a USB system software must be used for interpreting an arbitrary descriptor in order for the host to select an appropriate device driver in the prior art. However, in this embodiment, the determination only relied on a fixed hardware can be practiced without using the USB system software by predefining a predetermined portion of the descriptor of a device which supports a communication through the root repeater 102, and classifying devices only into three types: a hub, a USB device (supporting device), and a non-USB device. The result of determination is registered in the bus configuration register 122.

When the pattern determination unit 126 determines at step S166 that the connected device is a hub, the controller 120 acquires a configuration descriptor of the hub at step 76. The controller 120 “registers a status change end point number (written in the configuration descriptor)”, “initializes a data toggle of a status change pipe,” and “registers the connected device as a hub at an assigned address” in the bus configuration register 122.

At step 80, the controller 120 requests for setting configuration I (operating as a hub). At step S182, the controller 120 acquires a hub descriptor.

At step S184, the controller 120 “registers the number of ports and a port power mode” in the bus configuration register 122 from information written in the hub descriptor. At step S186, the controller 120 transmits a port power-on signal to the hub in accordance with this information.

After the completion of the foregoing processing, the root repeater 102 transits to the relay state 144. When the enumeration is executed from the detection of a connection at a hub port through the initialization of the hub port, the processing is continued from the port next to the hub port at which a connected device was detected, after completion of the enumeration.

If a port disconnection is detected at a root repeater port during the foregoing processing, the root repeater 102 returns to the connection waiting state 140.

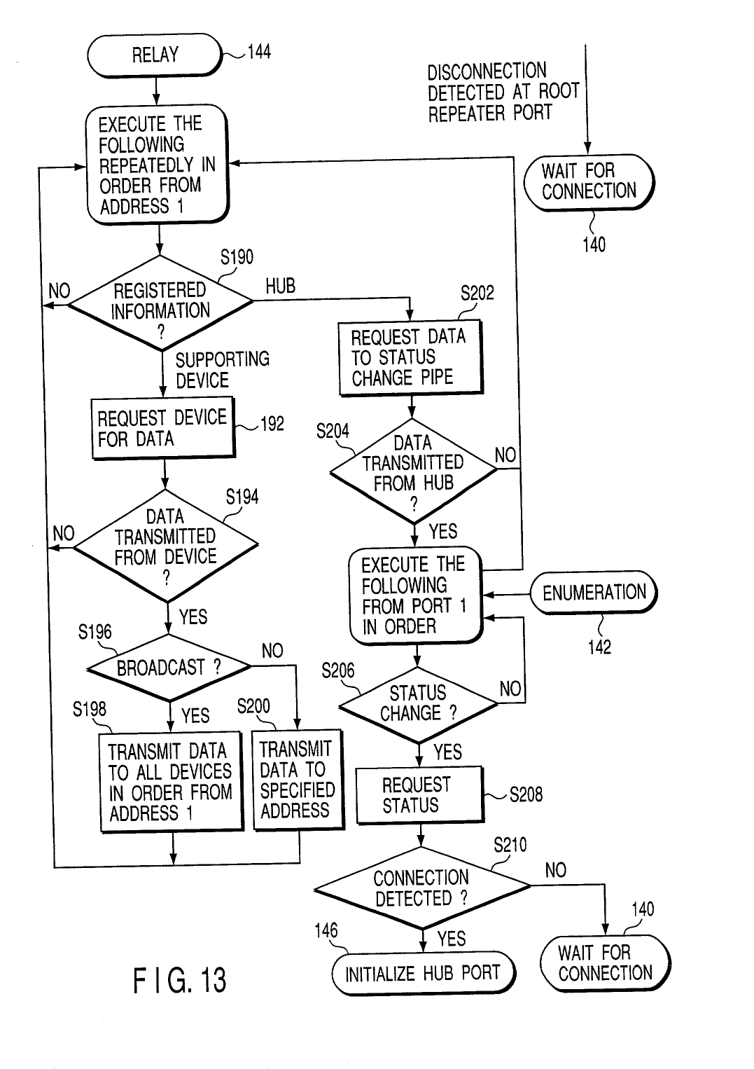

FIG. 13 is a flow chart showing the processing in the relay state 144 of the root repeater 102.

As the root repeater 102 enters the relay state 144, the controller 120 repeatedly executes the following processing for all hubs and devices connected to the bus from address 1 (predetermined value) in order. At step S190, the controller 120 determines from the bus configuration register 122 whether a device registered at a present address is a USB device, a hub, or a non-USB device.

When the device is the supporting device, the controller 120 starts an IN communication to a bulk IN pipe with the device to request the device for data at step S192.

At step S194, the controller 120 determines whether or not data has been transmitted from the device. If no data is transmitted, the controller 120 advances to the next address. When data is transmitted from the device, the controller 120 determines at step S196 whether or not the data is broadcast based on a destination address included in the data.

When the destination address specifies the broadcasting, the controller 120 performs a bulk OUT communication to each of addresses at which the supporting devices are registered from address 1 in order to transmit data at step S198. When the destination address specifies a particular address, the controller 120 performs a bulk OUT communication to that address to transmit data at step S200. With this processing, data can be transmitted to a particular device or broadcast in accordance with respective requirements of supporting devices connected to the system.

On the other hand, when the controller 120 determines at step S190 that the device registered at that address is a hub, the controller 120 refers a “status change end point number” stored in the bus configuration register 122 to start an interrupt IN communication to a status change pipe to request the hub for acquiring status change information at step S202.

At step S204, the controller 120 determines whether or not the status change information has been transmitted from the hub. If no information is transmitted, the controller 120 advances to the next address. When the status change information is transmitted from the hub, the controller 120 executes the following processing once from port 1 in order. In this event, at step S206, when a port bit is not set in the bus status change information (indicating that there is no status change), the controller 120 proceeds to the processing for the next port. If the port bit is set, the controller 120 starts an IN communication to a hub control pipe to request port status information at step S208.

The controller 120 determines at step S210 whether or not the port status information returned from the hub indicates connection detection, and the root repeater 102 transits to the hub port initialization state 146 when the connection detection is indicated, and returns to the processing for the next port (step S206) through the enumeration state 142.

At step S210, when the port status information returned from the hub indicates otherwise, the root repeater 102 transits to the connection waiting state 140.

When disconnection is detected at a root repeater port in the relay state 144, the root repeater 102 transits to the connection waiting state 140.

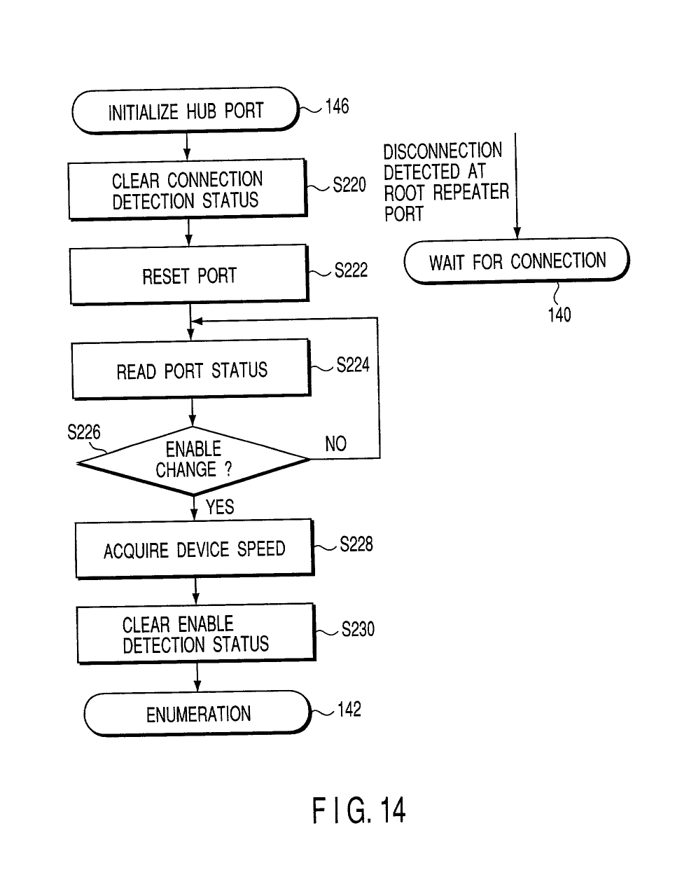

FIG. 14 is a flow chart showing the processing in the hub port initialization state 146 of the root repeater 102.

As the root repeater 102 enters the hub port initialization state 146, the controller 120 clears a connection detection status change bit of the associated hub through a hub control pipe at step S220, and performs a port reset at step S222.

At step S224, the controller 120 reads the port status for the hub through the hub control pipe to detect the completion of the port reset, and waits for a port enable change bit to be set at step S226.

As the port enable change bit is set, the controller 120 acquires a speed of the connected device from a port status value sent from the hub at step S228, and registers the speed in the bus configuration register 122. At step S230, the controller 120 clears an enable detection status change bit through the hub control pipe, and the root repeater 102 transits to the enumeration state 142.

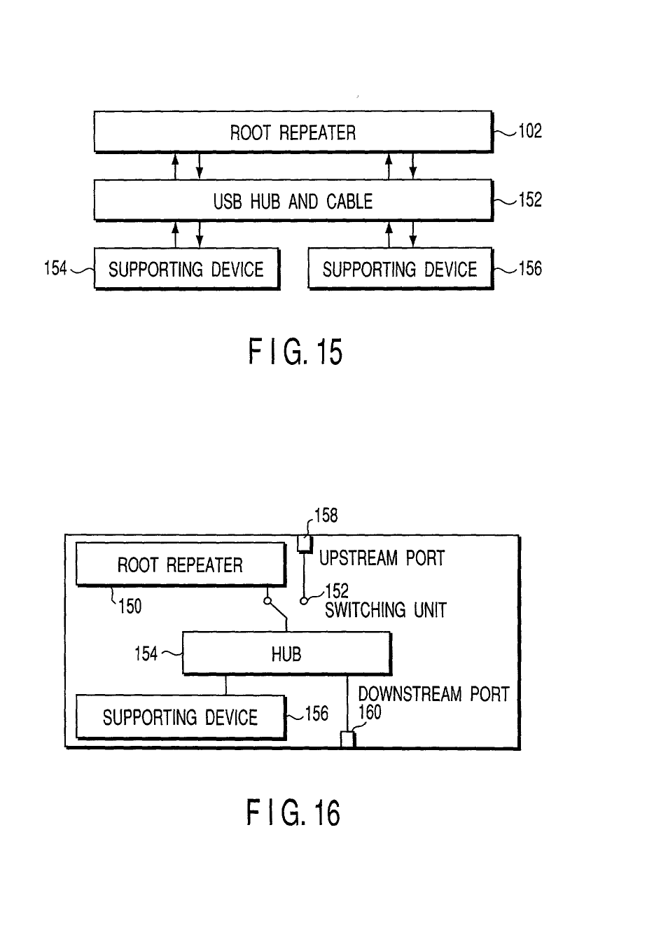

FIG. 15 is a diagram showing a feature of transferring data between devices in the first embodiment.

The root repeater 102 enumerates supporting devices 154 and 156 through a hub and cable 152 by the previously described method, and establishes two communication lines IN, OUT between itself and the respective supporting devices 154 and 156.

The root repeater 102 is only required to execute the operation in accordance with this embodiment, irrespective of the type of a connected device, and does not need a driver for each device, so that the root repeater 102 can be implemented only in hardware. Also, for making a device based on the conventional system support this system, only a firmware of the device need be modified. Specifically, in this embodiment, a unique configuration descriptor is provided and the firmware can be used to implement the operation of examining the existence of other supporting devices in the system and transferring data utilizing a broadcast transmission and one-to-one transmission when a unique configuration descriptor is set by the enumeration of the root repeater 102.

According to the first embodiment, the USB communication control apparatus comprises:

a controller which resets a whole bus and returns to a connection waiting state upon detecting a disconnection of USB device, registers devices connected to a system at sequential addresses beginning from a predetermined value, performs a bulk IN communication for each of the registered supporting devices, and responsive to data in a response from the device, sequentially broadcasts data to all the registered supporting devices or transmits the data to a particular address;

a bus configuration register which registers three device types including a hub, a USB device, and others using a device address as an index, wherein the contents of the bus configuration register is cleared when the controller enters the connection waiting state; and

a pattern determination unit which determines whether or not a connected device is a USB device based on whether or not the first portion of a configuration descriptor of the connected device matches a predetermined pattern.

According to this embodiment, when the controller enters the connection waiting state, the contents of the bus configuration register are cleared, thereby making it possible to reset the whole bus to start the enumeration for the whole bus when the operation is started, or when a device is disconnected anywhere on the bus.

Also, since it is ensured that devices existing on the bus always have sequential device addresses beginning from 1 by assigning the device addresses in order from a predetermined value in the enumeration for the whole bus, the root repeater 102 need not store the device tree topology. Therefore, the bus configuration register 122 having a smaller capacity and a simpler configuration, as compared with device tree information stored by the conventional host, can be used to register the device type, using the device address as an index, to attain the purpose.

The three types of devices, i.e., a hub, a USB device, and others are sufficient for an enumeration according to the present embodiment. The enumeration can be practiced only in hardware by determining a USB device with the three types of devices and based on whether or not the first portion of a configuration descriptor matches a predetermined pattern.

The root repeater 102 performs a bulk IN communication for each of registered supporting devices, and when receiving a response from a device, sequentially broadcasts data to all registered supporting devices or transmits the data to a particular address in accordance with the data, so that a USB device connected to the system can transmit data to a particular device or broadcast the data in accordance with the respective necessities of the devices. From the foregoing effects, the root repeater 102 can be implemented irrespective of the type of a connected device.

Also, according to this embodiment, a USB communication system comprises a USB communication control apparatus and a USB device. The USB communication control apparatus comprises:

a controller which resets a whole bus and returns to a connection waiting state upon detecting a disconnection of USB device, registers devices connected to a system at sequential addresses beginning from a predetermined value, performs a bulk IN communication for each of registered supporting devices, and responsive to data in a response from the device, sequentially broadcasts data to all the registered supporting devices or transmits the data to a particular address;

a bus configuration register which registers three device types including a hub, a USB device, and others using a device address as an index, wherein the contents of the bus configuration register is cleared when the controller enters the connection waiting state; and

a pattern determination unit which determines whether or not a connected device is a USB device based on whether or not the first portion a configuration descriptor of the connected device matches a predetermined pattern.

The USB device comprises a microprocessor, USB device controller hardware, and firmware which implements a function of mutually broadcasting data or communicating data on a one-to-one basis utilizing the USB communication control apparatus.

According to this embodiment, a USB device which mutually communicates data utilizing the root repeater 102 can be readily implemented only by adding the function to the firmware of the device without requiring drivers of the host.

The root repeater 102 provided by this embodiment can implement data transmission between devices with inexpensive hardware.

As described above, according to the foregoing embodiment, the processing in the connection waiting state 140 (FIG. 11) is provided, wherein the contents of the bus configuration register are cleared when the root repeater 102 enters the connection waiting state 140, thereby making it possible to reset the whole bus to start the enumeration for the whole bus configuration when the operation is started, and when a device is disconnected anywhere on the bus (step S150).

In the enumeration for the whole bus, since it can be ensured that the devices existing on the bus always have sequential device addresses beginning from 1 by assigning device addresses assigned in order from 1 (predetermined value) (step S162), the root repeater 102 need not store the device tree topology. Therefore, the bus configuration register 122 having a smaller capacity and a simpler configuration, as compared with device tree information stored by the conventional host, can be used to register the device type, using the device address as an index, to attain the purpose.

The three types of devices, i.e., a hub, a USB device, and others are sufficient according to the embodiment. The enumeration can be practiced only in hardware by determining a USB device with the three types of devices and based on whether or not the first portion a configuration descriptor matches a predetermined pattern.

Since the root repeater 102 sequentially transmits data to all of registered supporting devices (broadcasting) or to a particular address (steps S198 and S200), the supporting devices connected to the system can transmit data to a particular device or broadcast the data in accordance with respective necessities.

Since USB devices comprising a CPU and USB device controller hardware have been conventionally used in wide applications, supporting devices capable of communicating data with each other can be readily implemented only by adding required functions to the firmware of the devices and utilizing the root repeater 102 of this embodiment, without requiring drivers for the host.

Other embodiments of the USB communication control apparatus according to the present invention will be described. The same portions as those of the first embodiment will be indicated in the same reference numerals and their detailed description will be omitted.

Second Embodiment

FIG. 16 is a block diagram illustrating the USB communication control apparatus of the second embodiment. In this embodiment, a root repeater 150 having the same function as the root repeater 102 of the first embodiment, hub 154 and supporting device 156 are integrated into the control apparatus.

The control device can be used as the root repeater without a host by connecting an external USB device to a downstream port 160 and switching a switching unit 152 to the root repeater 102. Alternatively, the control device can be used as a device which contains a hub, similar to the prior art by connecting a host to an upstream port 158 and switching the switching unit 152 to the upstream port 158. It is possible to omit the switching unit 152 and upstream port 158 with connecting the hub 154 to the root repeater 102. The switching of the switching unit 152 may be manually performed by a user or automatically performed upon detection of a device connected to the upstream port 158 or downstream port 160.

As an exemplary application, a device which contains a printer as the supporting device 156, may be connected at the downstream port 160 to a cellular phone which comprises a USB device interface. Thus, the cellular phone can drive the printer.

Alternatively, a device which contains a memory card device as the supporting device 156 may be connected at the downstream port 160 to a cellular phone which comprises a USB device interface. Thus, the cellular phone can write/read data into/from the memory card device.

As described above, according to the foregoing embodiment, the USB communication control apparatus can be used without a host by connecting a USB device to the downstream port 160 and switching the switching unit 152 to the root repeater 102. Also, the USB communication control apparatus can be used as a device which contains a hub, similar to the prior art by switching the switching unit 152 to the upstream port 158, and connecting a host to the upstream port 158. Therefore, the USB communication control apparatus can be used not only in a use environment with a host but also in a use environment without a host.

According to this embodiment, a USB communication control apparatus comprises a root repeater, hub, upstream port, downstream port, and a switching unit for connecting the hub to the root repeater or to the upstream port, connecting an external supporting device to the downstream port, and switching the switching unit to the root repeater to perform a communication between the USB communication control apparatus and the external supporting device without a host personal computer, or switching the switching unit to the upstream port side, and connecting a host to the upstream port to perform a communication between the USB communication control apparatus and the host.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be implemented as a computer readable recording medium in which a program for allowing a computer to execute predetermined means, allowing the computer to function as predetermined means, or allowing the computer to realize a predetermined function is recorded.

What is claimed is:

1. A communication system comprising:
a device; and
a communication control apparatus configured to be connected to the device through a bus, the control apparatus comprising:
a controller configured to reset the bus, enter a connection waiting state upon detecting a disconnection of the device, register a connected device by giving addresses beginning from a predetermined value, and communicate with the registered device;
a pattern determination unit, responsive to detection of a connection of a device, configured to determine whether or not a connected device is the device based on a configuration descriptor of the connected device; and
a bus configuration register configured to register a device type including one of a hub, a first device, and a second device based on a device address of the connected device, wherein the bus configuration register is cleared when said controller enters the connection waiting state.

2. A USB communication control apparatus comprising:
a controller configured to reset a bus connecting a device and the communication control apparatus, enter a connection waiting state upon detecting a disconnection of the device, register a connected device by giving addresses beginning from a predetermined value, and communicate with the registered device;
a pattern determination unit, responsive to detection of a connection of a device, configured to determine whether or not a connected device is the device based on a configuration descriptor of the connected device; and
a bus configuration register configured to register a device type including one of a hub, a USB device, and a non-USB device based on a device address of the connected device, wherein the bus configuration register is cleared when said controller enters the connection waiting state.

3. A USB communication system comprising:
a USB communication control apparatus comprising:
a controller configured to reset a bus connecting a device and the communication control apparatus, enter a connection waiting state upon detecting a disconnection of the device, register a connected device by giving addresses beginning from a predetermined value, and communicate with the registered device;
a pattern determination unit, responsive to detection of a connection of a device, configured to determine whether or not a connected device is the device based on a configuration descriptor of the connected device; and
a bus configuration register configured to register a device type including one of a hub, a USB device, and a non-USB device based on a device address of the connected device, wherein the bus configuration register is cleared when said controller enters the connection waiting state;
a hub;
a USB supporting device comprising a USB device controller hardware;
an upstream port configured to be connected to a host device;
a downstream port configured to be connected to a USB device; and
a switching unit configured to selectively connect one of the upstream port and said USB communication control apparatus to said hub.

4. An apparatus according to claim 2, wherein said controller enters the connection waiting state when an operation is started; an enumeration state when the USB device is connected to a USB port and a port initialization is completed in the connection waiting state; a relay state when an enumeration is completed in the enumeration state; a hub port initialization state when detecting the USB device connected to a hub on the bus in the relay state; the connection waiting state when detecting a disconnection of the USB device on the bus in the relay state; the enumeration state when the port initialization is completed in the hub port initialization state; and the connection waiting state when the USB device is disconnected from the port which is being initialized in the hub port initialization state.

5. An apparatus according to claim 4, wherein:
said controller further comprises a connection/disconnection/device speed detector configured to detect a connection, a disconnection and a speed of the USB device, and a reset transmitter configured to output a reset signal defined in accordance with USB specifications;
said controller clears the bus configuration register when said controller is in the connection waiting state; waits for a notice of a connection of the USB device from said connection/disconnection/device speed detector; makes said reset transmitter to send a reset signal to an I/O unit in response to a detection of a connection of the USB device; is notified of a device speed from said connection/disconnection/device speed detector after the I/O unit has been reset; stores the device speed in said bus configuration register; and transits to the enumeration state.

6. An apparatus according to claim 4, wherein:
said controller acquires the device descriptor using a default address to know a communication packet size in the enumeration state; transmits a set address request using the default address; again acquires a descriptor address to determine a class code included in the descriptor address to determine whether or not the USB device connected to the port is a hub; acquires a configuration descriptor when a device connected to the port is not the hub and determines whether the device connected to the USB port is the USB device or not based on the configuration descriptor; requests to set a predetermined configuration when the connected device is the USB device and registers initialization of a data toggle of a relay communication pipe and as the USB device at an assigned address in the bus configuration register; and when a device connected to the USB port is a hub, acquires a configuration descriptor of the hub, registers a status end point number in the bus configuration register, initializes a data toggle of a status change pipe, and registers the device connected to the USB port as a hub at an assigned address.

7. An apparatus according to claim 4, wherein:
said controller sequentially determines in the relay state whether each of addresses registered in the bus configuration register indicates the USB device, the hub, or the non-USB device; starts a bulk IN communication to request the USB device for data when the USB device is registered, advances to the next address when no data is transmitted from the USB device; detects a destination address included in data when the data is transmitted from the USB device; sequentially performs a bulk OUT communication to transmit data for each of the addresses at which USB devices are registered when broadcasting is specified at the destination address; and when a particular address is specified at the destination address, performs a bulk OUT communication to the address to transmit data; when a hub is registered at the address, refers the status change end point number stored in the bus configuration register to communicate an interrupt IN communication to a status change pipe to request the hub for status change information; advances to the next address when the status change information is not transmitted from the hub; and responsive to the status change information from the hub, sequentially for respective USB ports of the hub, proceeds to processing for the next port when no status change is found, and starts an IN communication to a hub control pipe when a status change is found to request port status information.

8. An apparatus according to claim 4, wherein:
said controller clears a connection detection status change bit through a hub control pipe, and resets a USB port in the hub port initialization state; reads the port status through the hub control pipe for knowing that the USB port has been reset, and waits until a port enable change bit is set; acquires a speed of a connected USB device from a port status value and registers the speed in the bus configuration register; and clears an enable detection status change bit through the hub control pipe, and transits to the enumeration state.

9. A communication control method based on a root repeater which is capable of notifying data between devices, comprising:
upon detecting a disconnection of the device, resetting data for managing the configuration of a whole system, and entering a connection waiting state;
newly giving devices connected to a bus addresses in order from a predetermined value;
performing a communication for each of registered devices.

10. A USB communication control method for a USB communication system according to a USB communication system comprising:
a USB communication control apparatus comprising:
a controller configured to reset a bus connecting a device and the communication control apparatus, enter a connection waiting state upon detecting a disconnection of the device, register a connected device by giving addresses beginning from a predetermined value, and communicate with the registered device;
a pattern determination unit, responsive to detection of a connection of a device, configured to determine whether or not a connected device is the device based on a configuration descriptor of the connected device; and
a bus configuration register configured to register a device type including one of a hub, a USB device, and a non-USB device based on a device address of the connected device, wherein the bus configuration register is cleared when said controller enters the connection waiting state;
a hub;
a USB supporting device comprising a USB device controller hardware;
an upstream port configured to be connected to a host device;
a downstream port configured to be connected to a USB device; and
a switching unit configured to selectively connect one of the upstream port and said USB communication control apparatus to said hub, the method comprising:
connecting the USB device to the downstream port, switching the switching unit to the USB communication control apparatus to perform a communication for the connected USB device.

11. A communication system according to claim 1, wherein said controller sequentially broadcasts data to all registered devices or transmits the data to a predetermined device in response to a response from the device.

12. A USB communication control apparatus according to claim 2, wherein said controller sequentially broadcasts data to all the registered USB devices or transmits the data to a predetermined USB device in response to a response from the USB device.

13. A USB communication control method according to claim 9, wherein said performing the communication comprises sequentially broadcasting data to all registered devices or transmitting the data to a predetermined device in response to a response from the device.
